(19) United States
(12) Patent Application Publication
(10) Pub. No.: US 2024/0037629 A1
(43) Pub. Date: Feb. 1, 2024

(54) EV FIT MODELING BASED ON CONSUMER DATA

(71) Applicant: Toyota Connected North America, Inc., Plano, TX (US)

(72) Inventors: Mark A. McClung, Celina, TX (US); Joshua C. Batie, Frisco, TX (US); Imad Zahid, Carrollton, TX (US); Daniel E. Holman, Allen, TX (US); Gianna E. Coburn, Richardson, TX (US); Zach E. Stallbohm, Richardson, TX (US)

(73) Assignee: Toyota Connected North America, Inc., Plano, TX (US)

(21) Appl. No.: 17/877,122

(22) Filed: Jul. 29, 2022

(51) Int. Cl. G06Q 30/06; G01C 21/34; G06Q 30/02

(52) U.S. Cl. CPC G06Q 30/0631; G01C 21/3469; G06Q 30/0283

(57) ABSTRACT

A method for determining alternative fuel vehicle options for a driver includes obtaining, with a controller, a vehicle driving dataset for a first vehicle, where the vehicle driving dataset comprises CAN bus data of the first vehicle logged for a period of time, assigning points to one or more alternative fuel vehicles based on application of a set of point-based rules to one or more subsets of the vehicle driving dataset, identifying a second vehicle from the one or more alternative fuel vehicles having a greatest number of assigned points, and outputting an alternative fuel vehicle recommendation comprising the second vehicle.

### TECHNICAL FIELD

The present specification generally relates to determining an alternative fuel vehicle for replacing an owner's current vehicle. More specifically, systems and methods of the present disclosure employ artificial intelligence models to determine a recommendation for an alternative fuel vehicle based on vehicle driving data and information from an owner of the current vehicle.

### BACKGROUND

The selection of a vehicle to purchase, lease, or rent can include making many decisions. Typically, people determine what they need the vehicle for, what they are willing to spend, does the cost of ownership fit in their budget, and what vehicles are available. Once a few models are identified, a buyer may start customizing their selection, by selecting a color, factory installed accessories, and after-market accessories. Moreover, questions relating to how far a vehicle can travel on a single tank of fuel and how the number of passengers, amount of cargo, or type of usage, for example, were not of much concern as fueling stations are generally widely available and the time to refuel is typically a few minutes. However, as options for fully electric vehicles continues to grow, there are more questions relating to how electric vehicles compare with internal combustion engine type vehicles. Moreover, considerations that were not previously given much weight, such as how far a vehicle can travel on a single tank of fuel are becoming important purchasing factors. Additionally, there are many questions regarding how far a vehicle can travel on a single charge, how different driving habits or types of usage will affect the range of an electric vehicle, how long it takes to recharge the vehicle's power source, and many others that are either not relevant or non-existent with internal combustion engine vehicles. Such questions and considerations present a barrier to consider an electric vehicle and/or make a decision to purchase, lease, or rent a particular electric vehicle or other alternative fuel vehicle.

### SUMMARY

In some embodiments, a method for determining alternative fuel vehicle options for a driver includes obtaining, with a controller, a vehicle driving dataset for a first vehicle, where the vehicle driving dataset comprises CAN bus data of the first vehicle logged for a period of time, assigning points to one or more alternative fuel vehicles based on application of a set of point-based rules to one or more subsets of the vehicle driving dataset, identifying a second vehicle from the one or more alternative fuel vehicles having a greatest number of assigned points, and outputting an alternative fuel vehicle recommendation comprising the second vehicle.

In some embodiments, a method for determining alternative fuel vehicle options for a driver includes obtaining, with a controller, a vehicle driving dataset for a first vehicle, wherein the vehicle driving dataset comprises CAN bus data of the first vehicle logged for a predetermined period of time, transforming the vehicle driving dataset for the first vehicle into a set of alternative fuel parameters, determining, from a set of alternative fuel vehicles, a second vehicle having a specification that meets or exceeds a greatest number of parameters in the set of alternative fuel parameters, and outputting an alternative fuel vehicle recommendation comprising the second vehicle.

In some embodiments, a system for determining alternative fuel vehicle options for a driver includes a display device and a controller communicatively coupled to the display device, the controller comprising a processor and a non-transitory computer readable memory. The controller is configured to obtain a vehicle driving dataset for a first vehicle, wherein the vehicle driving dataset comprises CAN bus data of the first vehicle logged for a period of time, assign points to one or more alternative fuel vehicles based on application of a set of point-based rules to one or more subsets of the vehicle driving dataset, identify a second vehicle from the one or more alternative fuel vehicles having a greatest number of assigned points, and output to the display device an alternative fuel vehicle recommendation comprising the second vehicle.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 depicts an illustrative system for determining a recommendation for an alternative fuel vehicle according to one or more embodiments shown and described herein;

FIG. 2 schematically depicts components of a vehicle according to one or more embodiments shown and described herein;

FIG. 3 depicts an illustrative controller for implementing the method for providing an alternative fuel vehicle according to one or more embodiments shown and described herein;

FIG. 4A depicts a first portion of an illustrative flow diagram of processes for determining a recommendation of an alternative fuel vehicle according to one or more embodiments shown and described herein;

FIG. 4B depicts a second portion of an illustrative flow diagram of processes for determining a recommendation of an alternative fuel vehicle according to one or more embodiments shown and described herein;

FIG. 4C depicts a third portion of an illustrative flow diagram of processes for determining a recommendation of an alternative fuel vehicle according to one or more embodiments shown and described herein;

FIG. 4D depicts a fourth portion of an illustrative flow diagram of processes for determining a recommendation of an alternative fuel vehicle according to one or more embodiments shown and described herein;

FIG. 4E depicts a fifth portion of an illustrative flow diagram of processes for determining a recommendation of an alternative fuel vehicle according to one or more embodiments shown and described herein;

FIG. 5A depicts an illustrative graphical interface for display on a display device according to one or more embodiments shown and described herein;

FIG. 5B depicts another illustrative graphical interface for display on a display device according to one or more embodiments shown and described herein; and

FIG. 5C depicts depicts another illustrative graphical interface for display on a display device according to one or more embodiments shown and described herein.

### DETAILED DESCRIPTION

Embodiments of the present disclosure include systems and methods for determining a recommendation for a vehicle, such as an alternative fuel vehicle. The recommendation may be generated by a rule-point based model, artificial intelligence models, trained machine learning models, or the like that are configured to ingest a vehicle driving dataset, such as vehicle usage behavior from a consumer's current vehicle and optionally information from the consumer in response to survey questions, and output at least one recommendation of a vehicle, such as an alternative fuel vehicle.

Alternative fuel vehicles include a variety of vehicles. Types of alternative fuel vehicles generally include vehicles powered by biodiesel, electricity, ethanol, hydrogen, natural gas, propane, or another renewable or alternative fuel. Alternative fuel vehicles might employ an alternative fuel in combination with gasoline or diesel. For example, hybrid and plug-in electric vehicles may include gasoline or diesel engines to provide additional power or range to the electric power system, thereby decreasing the reliance on gasoline or diesel fuel. Some alternative fuel vehicles might even employ one or more different types of alternative fuels, such as electricity from a battery based system and hydrogen from a fuel cell based system. Electric vehicles may be powered by batteries. The type of battery chemistry and battery configuration can be tailored to deliver different performance specifications. For example, battery configurations may vary in the number of batteries in a battery pack, the voltage and/or capacity of a battery pack, the battery chemistry, the electronic components and configurations for power delivery and charging of the batteries in a battery pack, and the like. By tailoring the configurations, different specifications, such as range, power output, charging capability and time, cycle life, and the like can be delivered. The permutations and tradeoffs there between provide great challenges for a consumer to understand and determine a specification for an alternative fuel vehicle that is capable of delivering on performance, cost and/or environmental expectations.

As described in more detail herein, embodiments of the present disclosure are directed to reduce or remove barriers for a consumer to participate in, for example through the purchase, lease, or rental, the alternative fuel vehicle market. Consumers may have considered an alternative fuel vehicle to replace their current vehicle, which may be an internal combustion engine “ICE” vehicle or other alternative fuel vehicle such as a hybrid vehicle, or a consumer desires to reduce their environmental impact but does not have an efficient and intuitive process to determine what alternative fuel vehicle best fits their needs and desires. For example, translating the tradeoffs and benefits between ICE vehicles and the numerous alternative fuel vehicle options is not a trivial task. For starters, cost and environmental tradeoffs between fuel types is one consideration. Vehicle configurations that employ one or more alternative fuels, in combination with a variety of drive systems, such as all-wheel drive or two wheel drive, regenerative energy systems, a desired passenger and cargo capacity, towing capabilities, and the like, further complicate the selection of an alternative fuel vehicle as well as the cost and environmental tradeoffs thereof. Moreover, there are considerations that consumers of ICE vehicles rarely, if ever, need to consider. These considerations include, but are not limited to, how far an alternative fuel vehicle can travel with the on-board fuel (e.g., a single battery charge), how does the range of a vehicle change based on different driving behaviors, how long does it take to recharge or refuel, where are recharging or refueling locations, what alternative fuel is best for the type of driving a customer engages in, and the like.

Embodiments of the present disclosure significantly reduce or remove these complications in the selection process by utilizing vehicle driving data from a consumer's current vehicle to provide a recommendation of an alternative fuel vehicle that meets most or all of the consumer's needs. A score may be determined and assigned to the recommendation to indicate how well the recommendation meets the consumer's needs. For example, the systems and methods may provide a recommendation for an electric vehicle as a replacement option for a consumer's ICE vehicle.

The recommended parameters for an alternative fuel vehicle for the consumer are based on the consumer's vehicle usage behavior and optionally queried information from the consumer. In some embodiments, the vehicle usage behavior, which is quantified as a vehicle driving dataset, comprises controller area network “CAN” bus data from a consumer's ICE vehicle that is collected and compiled for a period of time. The period of time may be greater than or equal to 24 hours, optionally greater than or equal to 7 days, optionally greater than or equal to 30 days, optionally greater than or equal to 60 days, or optionally greater than or equal to 90 days. For example, using the past 90 days of historical data and optionally answers to survey questions from the customer, the system generates a customized electric vehicle “EV” recommendation for purchase, lease, or rental. The system may also determine a cost savings associated with using an EV instead of an ICE vehicle, for example, that is relevant to the consumer because it may be based on their specific vehicle usage behavior. The recommendation may further indicate an environmental impact to switching to the recommended EV and optionally a charging plan based on routes driven by the customer with locations indicating where the EV may be charged. Furthermore, recommended locations and times to charge may be provided based on the consumer's past driving routes and/or common locations, such as work, shopping, activity, or home locations.

In embodiments, a survey provided to the consumer may include questions such as whether the user would prefer charger access at work or home, how often the customer travels a predefined number of miles, whether the customer would be interested in using and/or participating in a carshare program, and the like. The system may further monitor or analyze CAN bus data from the consumer's current vehicle features to customize the alternative fuel vehicle recommendation. For example, the system may determine seat usage and/or seat belt data can indicate how often and the number of passengers on-board a vehicle, whether vehicle is used to tow a trailer, how often all-wheel drive mode or other drive system mode is used, how often the vehicle is operated in inclement weather, how often a safety system, traction control and/or vehicle stability control system is activated, and/or the like. In some embodiments, a consumer enable the system to access a personal calendar to determine whether the system can propose that vehicle may be used as a carshare during downtime and an amount that the customer would likely get paid for sharing the vehicle.

The following will now describe embodiments of the systems and methods in more detail with reference to the drawings and where like numbers refer to like structures.

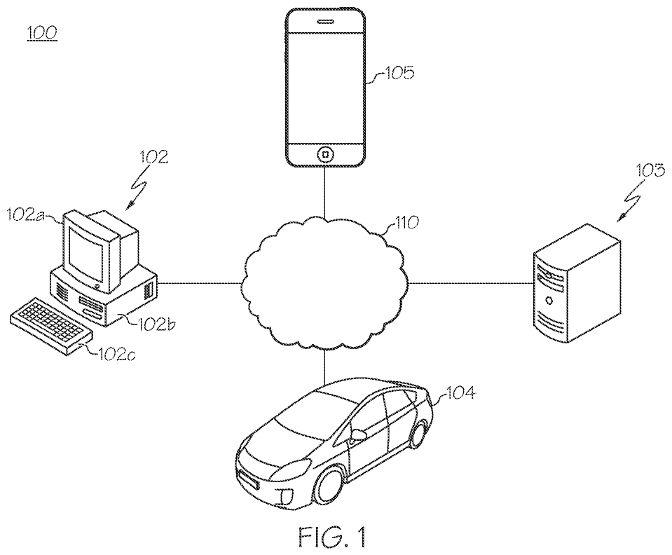

Referring to FIGS. 1-3, illustrative systems, vehicles, and computing devices for implementing processes for determining a recommended alternative fuel vehicle according to embodiments of the present disclosure are depicted. In particular, FIG. 1 depicts one example system 100 implemented via a network 110 configured to perform processes of the present disclosure. The system 100 may include an interconnection of one or more devices, such as a computing device 102, a server 103, a vehicle 104, and a mobile device 105. The devices may be interconnected over a network 110. The network 110 may include a wide area network, such as the internet, a local area network (LAN), a mobile communications network, a public service telephone network (PSTN) and/or other network. In some embodiments, the network 110 may represent a peer-to-peer type network between devices. As used herein, a controller refers to any one of the computing device 102, the server 103, or the mobile device 105. In embodiments, the process for determining a recommended alternative fuel vehicle according to embodiments of the present disclosure may be implemented by one of the computing device 102, the server 103, or the mobile device 105, or a combination of the computing device 102, the server 103, or the mobile device 105.

The computing device 102 may include a display 102a, a processing unit 102b and an input device 102c, each of which may be communicatively coupled together and/or to the network 110. The computing device 102 may be a desktop computer, a server 103 or a mobile device 105, such as a personal computer, a laptop, a tablet, a smartphone, an application specification handheld device, or the like. The mobile device 105 may include an input device, such as a touch screen or keypad, and a display. The mobile device 105 may further include components such as a GPS for determining a location of the mobile device 105, an inertial measurement unit for measuring acceleration and angular velocity of the mobile device 105 along three mutually perpendicular axes. In some embodiments, the mobile device 105 may be implemented to acquire diving behavior of a user while they are operating a vehicle. This information may be used in addition to or independently from CAN bus data, as described herein, to determine a recommended alternative fuel vehicle according to embodiments of the present disclosure.

The computing device 102 and/or the mobile device 105 may be used to enable the system 100 to access the CAN bus data from a vehicle 104 and/or for a user to provide information such as responses to survey questions to the system 100. The system 100 may also include one or more servers 103. The server 103 may be configured to perform one or more process steps of the methods described herein. For example, but without limitation, the sever 103 may be configured to provide a web based application to a computing device 102 or a mobile device 105 of the user to prompt the user for information and/or access to the CAN bus data of a vehicle 104. In some embodiments, as described in more detail herein, the server 103 is configured to ingest a vehicle driving dataset, implement an artificial intelligence model or trained machine learning model to transform ingested data into a set of alternative fuel parameters and determine a recommendation for an alternative fuel vehicle based on the transformation of the ingested data, and output the recommendation. The server 103 may be configured to access and record CAN bus data of a vehicle 104 for a predefined period of time or download previously logged CAN bus data from a vehicle 104, a computing device 102 or a mobile device 105. The server 103 may host a web based interface or an application that a user of a computing device 102 or mobile device 105 can access and interact with the process for determining a recommended alternative fuel vehicle according to embodiments of the present disclosure.

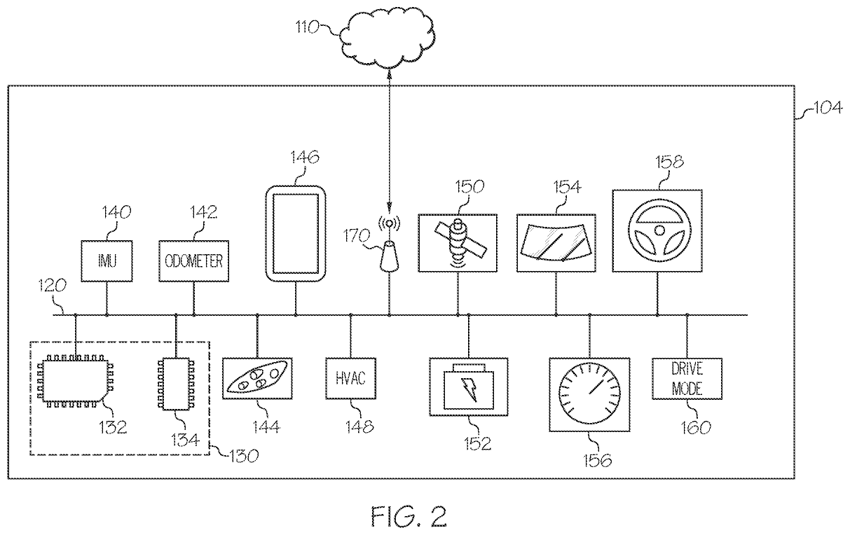

The vehicle 104 may be an automobile, a watercraft, an airplane, a motor bike, a motor scooter, or the like. Referring to FIG. 2, a schematic of illustrative components of the vehicle 104 connected to a CAN bus 120 is depicted. Vehicles 104 include many components and sensors interconnected together via a CAN bus 120, which enables operational monitoring and control of the vehicle 104. It should be understood that FIG. 2 depicts a set of illustrative components and sensors of a vehicle 104 and that various other components and sensors may be include in the vehicle 104. For example, the vehicle 104 may include a vehicle controller 130 comprising a processor 132 and a non-transitory computer readable memory 134, an inertial measurement unit 140, an odometer 142, vehicle headlamp unit 144, an infotainment system 146, an HVAC system 148, a location positioning system 150 (e.g., GPS), an auxiliary power system 152, a windshield wiper system 154, a vehicle speed sensor 156, a turning sensor system 158, a drive mode system 160, and network interface hardware 170. These and other components of the vehicle 104 are communicatively connected to each other via a CAN bus 120.

The CAN bus 120 may be formed from any medium that is capable of transmitting a signal such as, for example, conductive wires, conductive traces, optical waveguides, or the like. The CAN bus 120 may also refer to the expanse in which electromagnetic radiation and their corresponding electromagnetic waves traverses. Moreover, the CAN bus 120 may be formed from a combination of mediums capable of transmitting signals. In one embodiment, the CAN bus 120 comprises a combination of conductive traces, conductive wires, connectors, and buses that cooperate to permit the transmission of electrical data signals to components such as processors, memories, sensors, input devices, output devices, and communication devices. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium. As used herein, the term “communicatively coupled” means that coupled components are capable of exchanging signals with one another such as, for example, electrical signals via conductive medium, electromagnetic signals via air, optical signals via optical waveguides, and the like.

The vehicle controller 130 may be any device or combination of components comprising a processor 132 and non-transitory computer readable memory 134. The processor 132 may be any device capable of executing the machine-readable instruction set stored in the non-transitory computer readable memory 134. Accordingly, the processor 132 may be an electric controller, an integrated circuit, a microchip, a computer, or any other computing device. The processor 132 is communicatively coupled to the other components of the vehicle 104 by the CAN bus 120. Accordingly, the bus 120 may communicatively couple any number of processors 132 with one another, and allow the components coupled to the CAN bus 120 to operate in a distributed computing environment. Specifically, each of the components may operate as a node that may send and/or receive data. While the embodiment depicted in FIG. 2 includes a single processor 132, other embodiments may include more than one processor 132.

The non-transitory computer readable memory 134 may comprise RAM, ROM, flash memories, hard drives, or any non-transitory memory device capable of storing machine-readable instructions such that the machine-readable instructions can be accessed and executed by the processor 132. The machine-readable instruction set may comprise logic or algorithm(s) written in any programming language of any generation (e.g., 1GL, 2GL, 3GL, 4GL, or 5GL) such as, for example, machine language that may be directly executed by the processor 132, or assembly language, object-oriented programming (OOP), scripting languages, microcode, etc., that may be compiled or assembled into machine readable instructions and stored in the non-transitory computer readable memory 134. Alternatively, the machine-readable instruction set may be written in a hardware description language (HDL), such as logic implemented via either a field-programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components. While the embodiment depicted in FIG. 2 includes a single non-transitory computer readable memory 134, other embodiments may include more than one memory module.

Still referring to FIG. 2, the inertial measurement unit 140 includes one or more sensors for measuring and reporting angular rotation rates and accelerations in specific directions. For example, the inertial measurement unit 140 may include gyroscopes and accelerometers. The inertial measurement unit 140 may be configured to measure and report lateral accelerations of the vehicle 104 such as accelerations from in the lateral direction across the vehicle due to turning maneuvers and longitudinal accelerations of the vehicle 104 such as accelerations along the length of the vehicle due to speeding up or breaking the vehicle 104. The vehicle controller 130 may be configured to log, as a function of time, values of lateral acceleration, longitudinal acceleration, and angular rotations rates of the vehicle 104 as signals from the inertial measurement unit 140 are received over the CAN bus 120. An odometer 142 is also included on a vehicle 104 to measure the distance a vehicle 104 travels. The vehicle controller 130 may be configured to log as a function of time distances as traveled as signals from the odometer 142 are received over the CAN bus 120.

The vehicle 104 also includes a lamp unit 144, which is communicatively coupled to the vehicle controller 130 such that the individual lamps within the lamp unit 144 may be selectively activated and deactivated. The lamp unit 144 may include a number of lamp units disposed on the vehicle 104. The lamp units 144 on the front of a vehicle 104 may include a low beam lamp, a high beam lamp, a blinker lamp, a cornering lamp, and/or a fog lamp. The lamp units 144 on the rear of a vehicle 104 may include a brake lamp, a reverse lamp, a rear light lamp, and a blinker lamp. The vehicle controller 130 is configured to activate and deactivate the various lamps in the lamp units 144 via CAN bus 120. Additionally, the vehicle controller 130 may log when and which lamps are active.

An infotainment system 146 is also included in the vehicle 104. The infotainment system 146 may include a stereo system, navigation system, an entertainment system, a vehicle control center or the like. The infotainment system 146 consumes power when in operation. Accordingly, the vehicle controller 130 may configured to log when the infotainment system is active or how much power the infotainment system 146 consumes based on signals provided to the vehicle controller 130 over the CAN bus 120. Similarly, the vehicle controller 130 is configured to monitor the power consumption or activation time and settings of a heating, ventilation, and air conditioning “HVAC” system 148 of the vehicle 104. The HVAC system 148 includes heating components, blower components, condensing components and the like to control the climate within the vehicle 104 in response to user settings.

Still referring to FIG. 2, a location positioning system 150, such as a global positioning system, may be coupled to the CAN bus 120 and communicatively coupled to the vehicle controller 130 of the vehicle 104. The location positioning system 150 is capable of generating location information indicative of a location of the vehicle 104, for example, by receiving one or more GPS signals from one or more GPS satellites. The GPS signal communicated to the vehicle controller 130 via the CAN bus 120 may include location information comprising a National Marine Electronics Association (NMEA) message, a latitude and longitude data set, a street address, a name of a known location based on a location database, or the like. Additionally, the location positioning system 150 may be interchangeable with any other system capable of generating an output indicative of a location. For example, a local positioning system that provides a location based on cellular signals and broadcast towers or a wireless signal detection device capable of triangulating a location by way of wireless signals received from one or more wireless signal antennas. The vehicle controller 130 may monitor and log the locations a vehicle 104 travels as location tracking data defining a travel route of the vehicle 104. As described in more detail herein, the system 100 may be configured to utilize the travel route of the vehicle 104 in determining a recommendation of an alternative fuel vehicle and/or recommendations for recharging or refueling the alternative fuel vehicle based on the travel routes of a user of the vehicle 104.

The vehicle 104 also includes an auxiliary power system 152. The auxiliary power system 152 includes one or more AC and/or DC outlets for connecting peripheral devices to a vehicle 104. Peripheral devices may be connected to interface with the vehicle 104 and/or receive power from a power storage device of the vehicle 104. In some embodiments, the vehicle controller 130 monitors and logs the auxiliary power consumption via signals on the CAN bus 120. It should be understood that the auxiliary power system 152 may operate when ignition of the vehicle 104 is active or not active.

The vehicle 104 also includes a windshield wiper system 154 having motors to drive movement of the wipers across the windshield and optionally the rear window. The vehicle controller 130 logs the usage of the windshield wiper system 154. A vehicle speed sensor 156 is also included in the vehicle 104. The vehicle speed sensor 156 is coupled to the CAN bus 120 and communicatively coupled to the vehicle controller 130. The vehicle speed sensor 156 may be any sensor or system of sensors for generating a signal indicative of vehicle speed. For example, without limitation, a vehicle speed sensor 156 may be a tachometer that is capable of generating a signal indicative of a rotation speed of a shaft of the vehicle 104 engine or a drive shaft. Signals generated by the vehicle speed sensor 156 may be communicated to the vehicle controller 130 and converted a vehicle speed value. The vehicle speed value is indicative of the speed of the vehicle 104. In some embodiments, the vehicle speed sensor 156 comprises an opto-isolator slotted disk sensor, a Hall Effect sensor, a Doppler radar, or the like. In some embodiments, a vehicle speed sensor 156 may comprise data from a location positioning system 150 for determining the speed of a vehicle 104. The vehicle speed sensor 156 may be provided so that the vehicle controller 130 may determine when the vehicle 104 accelerates, maintains a constant speed, slows down or is comes to a stop. The vehicle controller 130 may log the speed of the vehicle 104 as a time dependent variable based on signals from the vehicle speed sensor 156 provided over the CAN bus 120.

Still referring to FIG. 2, the turning sensor system 158 may be coupled to the CAN bus 120 and communicatively coupled to the vehicle controller 130. The turning sensor system 158 may comprise a plurality of sensors located in the steering wheel for determining a driver grip on the steering wheel, the degree of rotation applied to the steering wheel or the forces applied in turning or maintaining the steering wheel. The vehicle controller 130 may log the degree of turns a vehicle 104 is maneuvered as a time dependent variable, which may further correspond to lateral accelerations recorded from the IMU 140. The values and/or others may be used to determine how hard a vehicle 104 is cornering as hard cornering can result in loss of momentum, thus requiring that the power system of the vehicle 104 provide more energy to return to a speed after a hard cornering event.

Additionally, a vehicle 104 may be enabled to be operated in different drive modes 160. Drive modes 160 include, for example, but are not limited to, two-wheel drive, four-wheel drive, towing mode, vehicle stability control, and the like. Selection of a drive mode 160 may be automatically implemented by a vehicle controller 130 in response to road conditions or events triggered by sensor inputs such as the loss of traction to one or more of the wheels of the vehicle 104. The selection of drive mode 160 may also be made manually by the driver. The vehicle controller 130 logs the selected drive mode and the system may utilize the selection of the drive mode 160 when analyzing the vehicle driving dataset to determine whether, for example, an acceleration event was power to two wheels or four wheels, which effects the energy of the drive system of the vehicle 104.

Still referring to FIG. 2, vehicles are commonly equipped with vehicle-to-vehicle communication systems. Some of the systems rely on network interface hardware 170. The network interface hardware 170 may be coupled to the CAN bus 120 and communicatively coupled to the vehicle controller 130. The network interface hardware 170 may be any device capable of transmitting and/or receiving data with a network 110 or directly with a device such as a computing device 102, a server 103, or a mobile device 105. Accordingly, network interface hardware 170 can include a communication transceiver for sending and/or receiving any wired or wireless communication. For example, the network interface hardware 170 may include an antenna, a modem, LAN port, Wi-Fi card, WiMax card, mobile communications hardware, near-field communication hardware, satellite communication hardware and/or any wired or wireless hardware for communicating with other networks and/or devices. In one embodiment, network interface hardware 170 includes hardware configured to operate in accordance with the Bluetooth wireless communication protocol. In another embodiment, network interface hardware 170 may include a Bluetooth send/receive module for sending and receiving Bluetooth communications to/from a network 110 and/or another vehicle and/or device.

As noted hereinabove, the components depicted in FIG. 2 of the vehicle 104 are exemplary in nature. Vehicles 104 may have fewer components or include other components not depicted and the vehicle controller 130 may log the activity of those components based on signals on the CAN bus 120.

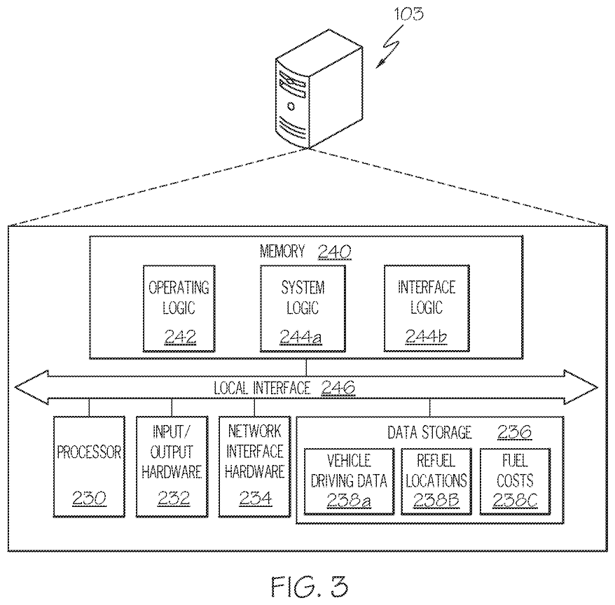

Turning to FIG. 3, an illustrative schematic of a controller, such as a sever 103, according to the embodiments of the present disclosure. While FIG. 3 depicts the controller as a server 103, it is understood that the processes described herein may be implemented on a computing device 102 or a mobile device 105. Moreover, it is understood that a server 103, a computing device 102 and/or a mobile device 105 may be implemented in the system 100 and execute one or more steps of the processes described herein. For purposes of explanation of the processes for determining a recommended alternative fuel vehicle according to embodiments of the present disclosure, the processes are described with reference to implementation by a server 103.

In some embodiments, the server 103 includes a processor 230, input/output hardware 232, network interface hardware 234, a data storage component 236, which may store a vehicle driving dataset 238a, a database of refuel locations 238b, and/or fuel costs 238c searchable by type and/or location, and a memory component 240. The memory component 240 may be machine readable memory (which may also be referred to as a non-transitory processor readable memory). The memory component 240 may be configured as volatile and/or nonvolatile memory and, as such, may include random access memory (including SRAM, DRAM, and/or other types of random access memory), flash memory, registers, compact discs (CD), digital versatile discs (DVD), and/or other types of storage components. Additionally, the memory component 240 may be configured to store operating logic 242, system logic 244a for implementing one or more of the methods described herein, and interface logic 244b for implementing one or more of the interactive interfaces described herein (each of which may be embodied as a computer program, firmware, or hardware, as an example). The system logic 244a may include one or more artificial intelligence models that are trained to receive a vehicle driving dataset for a first vehicle and determine from a set of alternative fuel vehicles a second vehicle that is an alternative fuel vehicle. The artificial intelligence models may include one or more machine learning models and/or access to databases. The databases may include, for example, a set of alternative fuel vehicle models defined by various alternative fuel parameters which may be adjusted to define a specification for an alternative fuel vehicle that best meets or exceeds a number of parameters discerned by the artificial intelligence model's processing of a vehicle driving dataset for a first vehicle. While embodiments described herein are generally discussed with reference to the first vehicle being an ICE vehicle, the methods and systems may also be applied to situations where the first vehicle is an alternative fuel vehicle. That is, there may be a better make and model of an alternative fuel vehicle for a user based on their driving needs or behaviors and/or the economics of fuel costs in the user's region. The term “better” may refer a vehicle having a lower emissions output than another, provide a greater cost savings through the operation of the vehicle, or the more completely deliver on the needs such as seating capacity, range, towing capability, cargo space, fuel economy, or the like.

As used herein, a region may be defined by a user's typical travel routes, a radius from their home, work, and/or school, a region around a location they are visiting for vacation or business for example, or the like. There may be various ways to define a user's region. In some embodiments, the user's region may be a predefined region such as by state, city, geographic location (e.g., northeast US, mid-Atlantic US, southeast US, southern US, west coast US, northwest US, northern Midwest US, Midwest US, or the like. A region may be defined based on climates or even infrastructure availability. For example, as resources such as charging locations for electric vehicles continue to become available, regions with different densities of vehicle charging locations may define a region. For example, such regions may be more favorable to fully electric vehicles than other regions, where it may be better for a user to own or operate a hybrid type vehicle because charging stations may be a scarcer resource in the area where the user travels.

A local interface 246 is also included in FIG. 2 and may be implemented as a bus or other interface to facilitate communication among the components of the controller.

The processor 230 may include any processing component(s) configured to receive and execute programming instructions (such as from the data storage component 236 and/or the memory component 240). The instructions may be in the form of a machine readable instruction set stored in the data storage component 236 and/or the memory component 240. The input/output hardware 232 may include a monitor, keyboard, mouse, printer, camera, microphone, speaker, and/or other device for receiving, sending, and/or presenting data. The network interface hardware 234 may include any wired or wireless networking hardware, such as a modem, LAN port, Wi-Fi card, WiMax card, mobile communications hardware, and/or other hardware for communicating with other networks and/or devices.

The data storage component 236 may reside local to and/or remote from the server 103 and may be configured to store one or more pieces of data for access by the computing device 102, the server 103, the vehicle 104, the mobile device 105 and/or other components. As illustrated in FIG. 3, the data storage component 236 may store the vehicle driving dataset 238a, refuel locations 238b, and/or fuel costs 238c. The vehicle driving dataset 238a is a quantification of driving behaviors of a user for a particular vehicle 104. The vehicle driving dataset 238a defines how a driver operates a vehicle so that the systems and methods described herein can translate the behaviors into parameters for an alternative fuel vehicle which meets a driver's needs. That is, the needs of a driver are extracted from the vehicle driving dataset 238a. For example, the vehicle driving dataset 238a can provide insights into driving speeds, accelerations and decelerations (e.g., informed by longitudinal acceleration), cornering (e.g., informed by lateral acceleration), distances driven during a period of time (e.g., a day, a week, a month, or more), travel routes, stopped locations, and the like. In embodiments, the vehicle driving dataset 238a includes CAN bus data. In some embodiments, vehicle driving dataset 238a can include data from other sources such as survey responses from a user, location information generated by components in the mobile device 105, and/or accelerations, speed, distance, and/or the like generated, for example, by an inertial measurement unit and location positioning system of the mobile device 105. In some embodiments, the mobile device 105 may provide a dataset that supplements or supplants the CAN bus data in the vehicle driving dataset 238a. By way of example, the CAN bus data includes odometer values, and time varying values of lateral acceleration, longitudinal acceleration, speed of the vehicle 104. In some embodiments, the CAN bus data further includes HVAC system usage, auxiliary power consumption, infotainment system usage, lamp usage, wiper usage, drive mode selection, and/or location tracking data. The usage information associated with the various systems and components of the vehicle 104 may include setting information, intervals in which the system is active, or other information corresponding to the operation of the system.

The data storage component 236 may also include refuel locations 238b. The refuel locations 238b may be a database of locations where refueling or recharging resources are located. The refuel locations 238b may be defined by location information, the type of refueling or recharging resources available, capacity, and other information. The refuel locations 238b can be updated from time to time so that the information can include current usage information such as how many stations are available. Additionally, the data storage component 236 may include fuel costs 238c. The fuel costs 238c may be a component of the refuel locations 238b such that a cost per unit (e.g., gallon, watt, liter, etc.) is accessible. The fuel costs 238c may include the minimum, maximum, average, and current costs for different types of fuel within a region. That is, since the price of fuel can vary between regions, by having fuel costs that are tailored to a user's region a more accurate recommendation for an alternative fuel vehicle, as described in more detail herein, may be determined. The refuel locations 238b and fuel costs 238c may be searchable by fuel type and/or location.

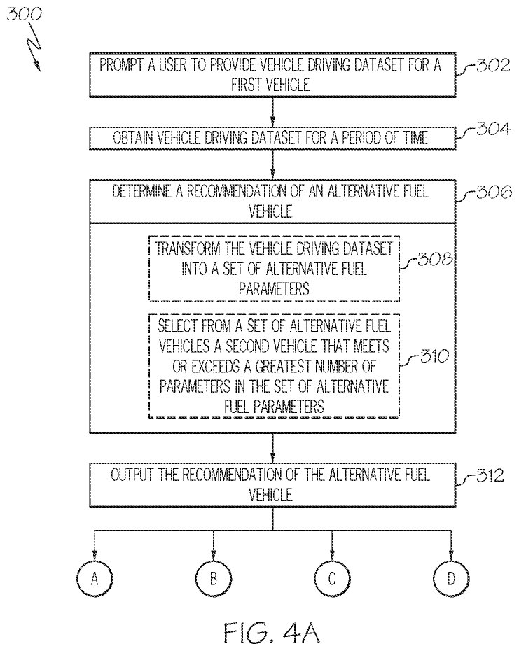

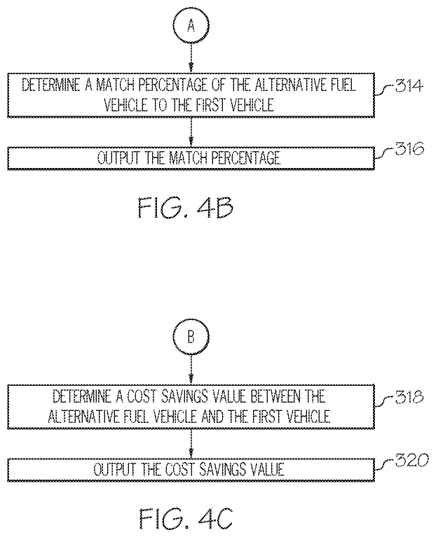

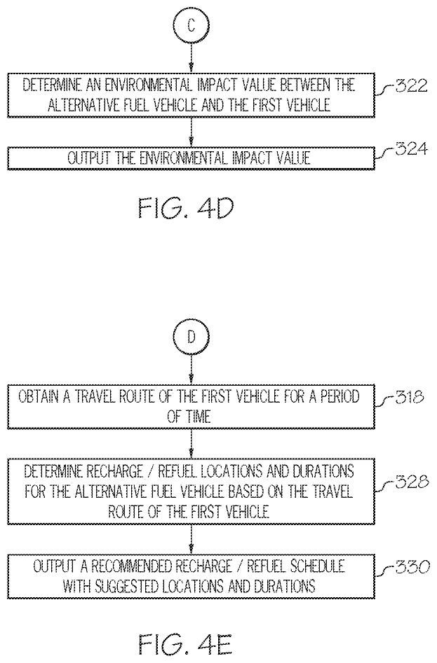

Methods implemented by the server 103, computing device 102, the mobile device 105 and the vehicle 104 will now be described in more detail with respect to the flow diagrams depicted in FIGS. 4A-4E. FIGS. 4A-4E will be discussed together with reference to the description herein.

Embodiments include processes for determining a recommendation of an alternative fuel vehicle. The recommendation process may be deployed as part of a tool for a user, which is also referred to herein as a consumer, customer, and driver, to assist in translating between the many ICE vehicle and alternative fuel vehicle options. In particular, the tool may be a phone based application or a web-based application enabling a user to interact with information generated by their vehicle. In some embodiments, the tool may be a dealer or manufacturer system for potential customers of a vehicle. The tool may also be deployed as part of a rental vehicle reservation process in which a user can leverage the vehicle driving dataset generated by their personal vehicle or a previous rental vehicle to assist with making a reservation of a vehicle such as an alternative fuel vehicle that best fits their needs and desires such as having a low environmental impact. These are only a few examples where the process for determining a recommendation of an alternative fuel vehicle as described herein may be deployed.

Turning to FIGS. 4A-4E, illustrative flow diagrams 300 defining processes for determining a recommendation of an alternative fuel vehicle are depicted. In some embodiments, the method may be initiated by user interested in purchasing, leasing, renting, or curious in determining a recommendation for an alternative fuel vehicle based on a vehicle driving dataset from their current vehicle. In one embodiment, the tool for determining a recommendation for an alternative fuel vehicle may be embedded within an application on a user's mobile device 105. As such, a user may initiate the tool by opening the application or selecting the tool within the application. Once initiated, at block 302, the method may prompt a user to provide the tool with a vehicle driving dataset 238a for a first vehicle 104. The first vehicle 10, for example, refers to a user's current vehicle. The first vehicle 104 may be an ICE vehicle or an alternative fuel vehicle. For purposes of explanation herein, the first vehicle 104 can be assumed to be an ICE vehicle.

The prompt to provide the vehicle driving dataset 238a may include a request to access a vehicle's CAN bus 120 via a network connection between the vehicle 104 and a server 103, for example. The prompt may include a request and interface for a user to attach, upload, or enable a connection to a saved log of CAN bus data or movement data recorded by the mobile device 105. In some embodiments, the prompt may request that a user to start a logging process whereby a connection between the CAN bus 120 of the vehicle 104 and the mobile device 105 may be established for a driving session. Throughout the driving session, a memory component of the mobile device 105 may log CAN bus data from a vehicle or log movement data generated by sensors connected to the mobile device 105. In some embodiments, the prompting process may include configuring a mobile device 105 to record and/or transmit CAN bus data from the vehicle 104 to the server 103 each time the mobile device 105 detects that a driving event performed by the user is underway. In this way, the mobile device 105 may act as a trigger for the recording of CAN bus data into a vehicle driving dataset 238a in a data storage component 236. This may continue until a sufficient amount of data is collected to perform an analysis, or for a predetermined amount of time, or for a predetermined number of driving events. A sufficient amount of data may be indicated based on a diversity of data or when a statistically significant number of events are determined to be captured within the vehicle driving dataset 238a. In other instances, each time new data is generated and added to the vehicle driving dataset 238a, the analysis as described here may be performed. This collection and subsequent analysis may continue to be performed until a convergence upon a recommendation is achieved. In such an embodiment, a user may continue to passively allow the system and method to run until being alerted by the system that a recommendation is ready to be output.

At block 304, the process continues with obtaining the vehicle driving dataset 238a. As previously discussed, there may be several methods in which the vehicle driving dataset 238a is obtained. In addition to the aforementioned ways in which the vehicle driving dataset 238a is obtained, either through collection processes over time or received as a single dataset of previously recorded data, obtaining the vehicle driving dataset 238a may include the solicitation and collection of a survey including questions posed to a user. The survey may seek out information that may not be able to be determined from CAN bus data, but may be relevant to vehicle driving behaviors and/or vehicle diving desires of a user.

For example, a user may desire to drive a zero emission vehicle or only be interested in an electric vehicle. The user or a member of the user's household may already own an alternative fuel vehicle, so implementation of any infrastructure at a house location may not be needed. Similarly, a survey may include requests for the user provide home, work, school and/or other location they may frequent so that a determination can be made as to whether the locations can support, for example, an electric vehicle recharging station. Such inquires may also ask a user to provide their electrical delivery configuration and/or energy provider so that energy rates (e.g., fuel costs 238c) and/or infrastructure resources may be included in the analysis. The survey may also seek out information relating to how a user intends to use a vehicle. This may include transporting people such as family members, friends, or for ride-sharing. Other uses may include using the vehicle to transport cargo, tow a trailer, or as a commuting vehicle. These are only a few examples of subject matter that may be solicited from the user and included in the vehicle driving dataset 238a.

As the vehicle driving dataset 238a is being generated or once the vehicle driving dataset 238a is generated and received, for example, by the server 103, the server 103 analyzes the vehicle driving dataset 238a using the system logic 244a. There are several ways in which the system logic 244a can be configured for analyzing the vehicle driving dataset 238a to determine a recommendation of an alternative fuel vehicle at block 306. In some embodiments, the system logic 244a may include a plurality of rules. The system logic 244a in analyzing the vehicle driving dataset 238a determines which rules of the plurality of rules are met. The degree in which the vehicle driving dataset 238a meets a particular rule may be defined by a number of points within a range of points assigned to the particular rule. As used herein, a set of point-based rules refers to the aforementioned process of determining and assigning points based on the degree in which a particular rule is met by the vehicle driving dataset 238a. For example, a rule of the plurality of rules may be at least 50% of drives included in the vehicle driving dataset 238a are less than or equal to an average range of a plug-in hybrid electric vehicle's range. If the criteria for the rule is satisfied a point may be assigned to one or more power train types of alternative fuel vehicles. For example, hybrid electric vehicles may receive 0 points, while the plug-in hybrid electric vehicle types and battery electric vehicle types may each receive 1 point. Another rule, for example, may include determining whether at least 50% of drives included in the vehicle driving dataset 238a are greater than the average range of a plug-in hybrid electric vehicle's range. If the criteria is satisfied, then hybrid electric vehicle types may receive 0.5 points and battery electric vehicle types may receive 1 point, while plug-in electric vehicles receive 0 points. Table 1 below depicts several additional example rules defined by a set of criteria and an assignable point value to each powertrain type that meets the criteria.

TABLE 1

| | Points Assigned to Powertrain | | |
|---|---|---|---|
| | Type when Criteria of Rule is met | | |
| Criteria | HEV | PHEV | BEV |
| 50% of drives <= average PHEV range (+5 miles) | | 1 | 1 |
| (BEV charges/Monthly total number of trips) <= 1/3 | | | 1 |
| 50% of drives > average PHEV range (+5 miles) | 0.5 | | 1 |
| >0 Passive Charging Stations on common routes | | 2 | 2 |
| 0 Passive charging stations on common routes | 2 | | |
| >5 Active Charging Stations on Common routes | | 1 | 1 |
| 0 Active Charging Stations on Common routes | 2 | | |
| >0 and <=5 Active Charging Stations on common routes | | 1 | |
| Own House (option to install charging station) | | 1 | 1 |
| Tax Credit (if applicable) | | | 0.5 |
| No charging stations in area of travel and cannot charge at | | −1000 | −1000 |
| home | | | |
| 10% of trips over 2*BEV range | 2 | 2 | 0 |
| 10% of trips not over 2*BEV range | | | 1 |
| 75% of trips >= BEV range (−10 miles) | 1 | | |

The powertrain types considered in the example set of rules depicted in Table 1 include REV, hybrid electric vehicles, PHEV, plug-in electric vehicles, and BEV, battery electric vehicles. HEVs refer to vehicles powered by an internal combustion engine in combination with one or more electric motors that use energy stored in batteries, for example. PHEVs refer to vehicles that use batteries to power an electric motor as well as another fuel, such as gasoline or diesel, to power an internal combustion engine or other propulsion source. PHEVs can charge their on-board power storage unit (e.g., batteries) through electricity from the power grid or through regenerative breaking. A key difference between many HEVs and PHEVs is that HEVs cannot plug in to off-board sources of electricity to charge the battery. Instead, HEVs rely on regenerative breaking and other power regeneration processes implemented on the HEV itself. BEVs refer to all-electric vehicles that use electrical energy from an on-board power storage unit to power an electric motor for propulsion.

Still referring to Table 1, it should be understood that the rules and points depicted therein are merely illustrative. Additionally, there may be additional powertrain categories that are scored based on the analysis of the vehicle driving dataset 238a. Moreover, there may be instances where survey feedback from the driver is utilized to obtain additional information for refining a recommendation, such as whether a driver owns their own home such that they may be able to install a home charging station.

Additionally, as shown in Table 1, average PHEV range, BEV range, BEV charges, and the like refer to predefined values that the rules may implement to make a determination as to whether the vehicle driving dataset 238a satisfies a rule. For example, BEV charges may refer to the total distance traveled in a month by a user divided by a predefined range (e.g. miles on a single) value for BEVs. Additionally, passive charging stations may refer to those within a half mile radius of where a vehicle has been turned off (e.g. parked) for a period of time. The presence of a passive charging station within a predefined range of a work, school, or home location of a driver may indicate that a driver may slightly change their routine to accommodate charging of their PHEV or BEV vehicle while they are at work, school, or home. Active charging stations may refer to those along travel routes of the driver based on vehicle driving dataset 238a but not within a predefined range of turning off (e.g. parking) of their vehicle. These are charging stations that can be recommended to a user to stop and charge at along their route. Common routes may be routes that a driver traverses on a frequent basis such as a daily work or school commute, a weekend destination that is frequented for a number of weekends in a row such as trips to a shopping center, ball field, park, or the like.

In some instances, the rules may assign negative values to a powertrain. For example, if there are no charging locations in an vicinity of travel of a driver and/or they are not able to charge a vehicle at home, a recommendation of a PHEV or BEV should not be considered, thus may be assigned a negative value of points.

Referring back to block 306 of FIG. 4A, the determination of a recommendation of an alternative fuel vehicle may be determined based on a rules system as previously described. In a rules-based system logic 233a, if there is a tie between different powertrain options, the system logic 233a may be predefined to select one powertrain over another. For example, should a tie result between PHEV and BEV, BEV may be predefined to supersede a PHEV recommendation. Moreover, once a powertrain is identified, a further set of rules may be applied in the analysis of the vehicle driving dataset 238a to refine the recommendation to a specific trim level and/or additional features. For example, a BEV powertrain may be initially determined, but through further analysis of the vehicle driving dataset 238a, it may be determined that a BEV with a long range power storage unit would be beneficial to a driver based on satisfaction of one or more additional rules or which aligns to survey response provided by the driver.

In other embodiments or in combination with a rules-based system, the system logic 244a may include an artificial intelligence model trained to determine a recommendation of an alternative fuel vehicle based on the vehicle driving dataset 238a of the first vehicle 104 at block 306. The artificial intelligence model may be one of a variety of models including but not limited to a machine learning model. The artificial intelligence model includes several functions. For example, the artificial intelligence model analyzes the vehicle driving dataset 238a and detect patterns indicative of driving behaviors. In some embodiments, the artificial intelligence model or more specifically, a machine learning model may be trained to transform the vehicle driving dataset 238a into a set of alternative fuel parameters, for example, at block 308. The process of transforming the vehicle driving dataset 238a into the set of alternative fuel parameters include, for example, determining energy usage or energy generation units based on data such as distance traveled, speed, longitudinal accelerations, and lateral accelerations. The energy usage or energy generation units may then be translated into a set of alternative fuel parameters, for example, electrical power parameters. The set of alternative fuel parameters may define or be attributed to specification of an alternative fuel vehicle, for example, at block 310.

At block 310, the artificial intelligence model may ingest a set of alternative fuel vehicles. The set of alternative fuel vehicles may include commercially available vehicle specifications. In some embodiments, the set of alternative fuel vehicles may include a template for an alternative fuel vehicle, having definable specification parameters that may or may not correspond to a production or commercially available. The definable specification parameters may be selected based on the set of alternative fuel parameters such that a specification for an alternative fuel vehicle is generated. In some instances, implementation of the artificial intelligence model at block 306 may include multiple artificial intelligence models. Each of the multiple artificial intelligence models may be trained to analyze the vehicle driving dataset 238a from a first type of vehicle, such as an ICE vehicle, a plug-in hybrid, a battery electric vehicle, a hybrid vehicle a fuel cell vehicle, a hybrid electric vehicle, or the like and determine a recommendation for a second type of vehicle such as an ICE vehicle, a plug-in hybrid, a battery electric vehicle, a hybrid vehicle a fuel cell vehicle, a hybrid electric vehicle, or the like. In other words, there may be an artificial intelligence model that is specific for each type of alternative vehicle.

Whether the process at block 306 implements one artificial intelligence model or multiple vehicle specific artificial intelligence models, the process may include generating an alternative fuel vehicle option for a number of alternative fuel vehicle types based analysis of the vehicle driving dataset 238a from the first vehicle 104. For example, input of the vehicle driving dataset 238a from the first vehicle 104 can result in multiple alternative fuel vehicle options, each having a different specification and/or a different alternative fuel type. The process of determining a recommendation of an alternative fuel vehicle performed at block 306, may include the sub process of selecting from the set of alternative fuel vehicles a second vehicle that meets or exceeds the greatest number of parameters in the set of alternative fuel parameters, at block 310.

In some embodiments, the artificial intelligence model may also ingest location tracking data as part of the vehicle driving dataset 238a. The location tracking data may be analyzed to determine one or more travel routes associated with the driving events defined by other data in the vehicle driving dataset 238a. For example, one or more travel routes over a period of a week may include commutes to and from work, shopping trips, stops at schools or daycare facilities, and/or the like. The artificial intelligence model may utilize the various locations, the durations spent at each location, and nearby resources to develop a recommendation for refueling or recharging events that correspond with a user's typical travel routes. The location tracking data and/or fuel level data included in the vehicle driving dataset 238a may be analyzed to determine how often and when a user refuels their ICE vehicle or other type of vehicle. Refueling history analysis may provide an indicator of fuel awareness of the driver. For example, some drivers may only refuel when they are close to empty, for example, when the refueling light turns on. Some drivers may refuel each time every week before a particular activity or based on some other external trigger, not fuel level. Meanwhile, some driver may have fuel anxiety whereby they refuel whenever the fuel level reaches a particular level, for example, half or quarter full. Such behavioral patterns may be determined by the artificial intelligence model through analysis of the vehicle driving dataset 238a.

At block 312, the process includes outputting an alternative fuel vehicle recommendation including the second vehicle, which is the selected alternative fuel vehicle. The output process at block 312 may include causing a display device, such as a display of the mobile device 105 of the user to display an image and vehicle model of the second vehicle. The output process may include sending an electronic message such as a text message, an email, or the like to the user and/or a vehicle dealer. In some instances, the output process may also include facilitating a test drive of the recommended vehicle. Moreover, in some embodiments the output process at block 312 may result in presenting a ranked list of recommended alternative fuel vehicles to the user. The ranked list, as described in more detail herein, may include various types of alternative fuel vehicles and score associated with each relating to fit to a driver's driving behaviors, energy savings, a quantification of an environment impact, or the like.

In addition to the process of outputting the recommendation of the alternative fuel vehicle at block 312, one or more additional outputs may be determined and output to the user. FIGS. 4B-4E illustrate the one or more additional processes that may be executed by the system 100. It should be understood that each of the additional process may executed simultaneously or sequentially. Additionally, only one or a few of the additional processes may be executed. Referring to FIG. 4B, the system 100 may be configured to further determine a match percentage of the alternative vehicle to the first vehicle at block 314. The match percentage is a numerical value indicating how well the recommended alternative fuel vehicle will be able to deliver the performance and functionality of the first vehicle as defined by the vehicle driving dataset 238a. The match percentage may be a measure based on a comparison between the specification of the alternative fuel vehicle and the set of alternative fuel parameters based on the vehicle driving dataset 238a of the first vehicle 104. At block 316, the match percentage is output to the user. For example, the match percentage may be output as part of the recommendation of the alternative fuel vehicle at block 312. The match percentage may be output to the display device of the mobile device 105 of the user or a computing device 102.

Referring to FIG. 4C, the system 100 may be configured to perform a cost analysis including a comparison of the fuel cost and/or the cost of operation of the recommended alternative fuel vehicle and the first vehicle 104. At block 318, the system 100 is configured to determine a cost savings value between the alternative fuel vehicle and the first vehicle 104. The determination of the cost savings value may be based on the comparison of the fuel cost and/or the cost of operation of the recommended alternative fuel vehicle and the first vehicle 104. The fuel costs that are used can be limited to the fuel costs of the region or regions in which the first vehicle 104 is operated. Additionally, the cost of operation may be based on driving events determined from the vehicle driving dataset 238a of the first vehicle 104. In this way, the cost savings value can be particularized to the operation and fuel costs that are relevant to the user. At block 320, the cost savings value is output to the user. For example, the cost savings value may be output as part of the recommendation of the alternative fuel vehicle at block 312. The cost savings value may be output to the display device of the mobile device 105 of the user or a computing device 102.

Referring to FIG. 4D, the system 100 may be configured to perform an environmental impact analysis based on a comparison of the emissions generated between the recommended alternative fuel vehicle and the first vehicle 104 at block 322. The comparison may be based on the carbon emissions or the equivalent carbon emissions of each vehicle. The environmental impact analysis may estimate the carbon footprint of the alternative fuel vehicle. The estimate of the carbon footprint of the alternative fuel vehicle may be based on a vehicle usage determined from analysis of the vehicle driving dataset 238a of the first vehicle. The environmental impact analysis determines an environmental impact value and outputs the same at block 324. At block 324, the environmental impact value is output to the user. For example, the environmental impact value may an emissions savings value compared to the first vehicle, a carbon footprint of the alternative fuel vehicle, or the like. The environmental impact value may be translated to units readily understood by a driver, such as the number of trees saved by switching to an alternative fuel vehicle. The environmental impact value may be output as part of the recommendation of the alternative fuel vehicle at block 312. The environmental impact value may be output to the display device of the mobile device 105 of the user or a computing device 102.

Turning to FIG. 4E, a process for generating a recommended recharge or refuel schedule with suggested locations and durations is depicted. At block 326, the system obtains a travel route of the first vehicle for a period of time. As described herein, the vehicle driving dataset 238a may include location tracking data that defines travel routes of the first vehicle 104. The travel routes may correspond to a driver's typical schedule over the period of time in which the data is collected. In some embodiments, a schedule of activities for a user may be uploaded to or accessible by the system 100. At block 328, the system 100 determines one or more recharge or refuel locations present along the travel route and/or at or nearby stops indicated by the travel route. Stop over times at the stops indicated by the travel route may also be determined. Accordingly, the system can determine a recommendation for recharge or refuel locations and durations for recharging or refueling the alternative fuel vehicle at block 328. The recommendations may coincide with stop over times so that a user can take advantage of times the vehicle is not used to refuel or recharge. At block 330, the recommendation for recharge or refuel locations and durations for recharging or refueling the alternative fuel vehicle may be output, optionally they may be output as part of the recommendation of the alternative fuel vehicle at block 312. The recommendation for recharge or refuel locations and durations may be output to the display device of the mobile device 105 of the user or a computing device 102. In some embodiments, a map may be displayed outlining the various routes a user typically traverses. The map may include pins identifying locations and recommended durations for charging or fueling at the locations. In some embodiments, the recommendations may be provided by further taking into account current behavior that a user engages in with respect to refueling their first vehicle 104, such as an ICE vehicle. For example, someone with fuel anxiety might be offered more locations and more recommended more frequent recharge or refueling events. In some embodiments, a schedule of a user may be annotated with recommend recharge or refueling events so that a user is reminded, for example, when they go to the grocery store to find a parking location with a charger and recharge their vehicle. Reminders or recommendation may also occur on an unscheduled basis such as when the system 100 determines that a user is at a location they typically spend time at, for example, a workout center but have traveled to the location at a time different than when they usually do. However, the system 100 can learn that when a user travels to specific locations they tend to spend a predefined amount of time at those locations. As such, the system 100 may recommend that they recharge or refuel, upon arriving at that location. It should be understood that these are only a few examples and that recommendations for recharging and refueling may be based on other events discerned from an analysis of the vehicle driving dataset 238a of the first vehicle 104.

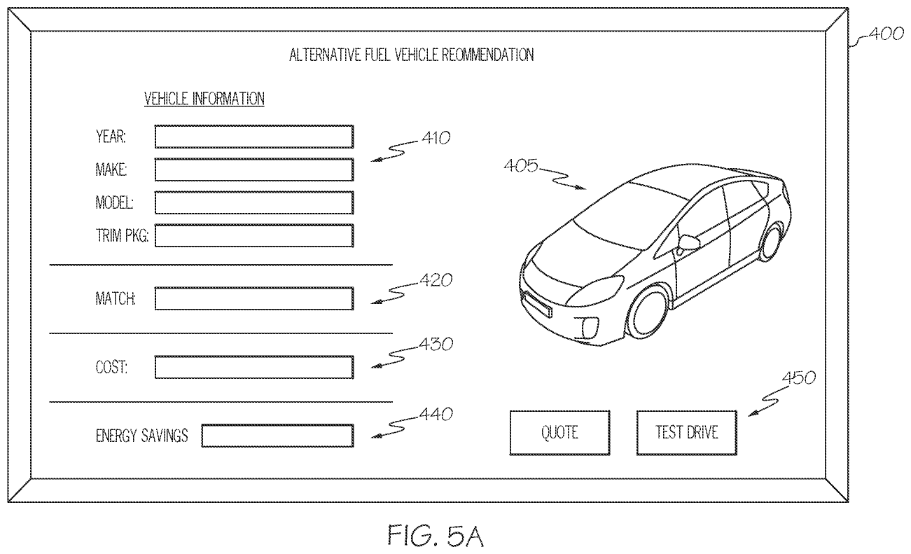

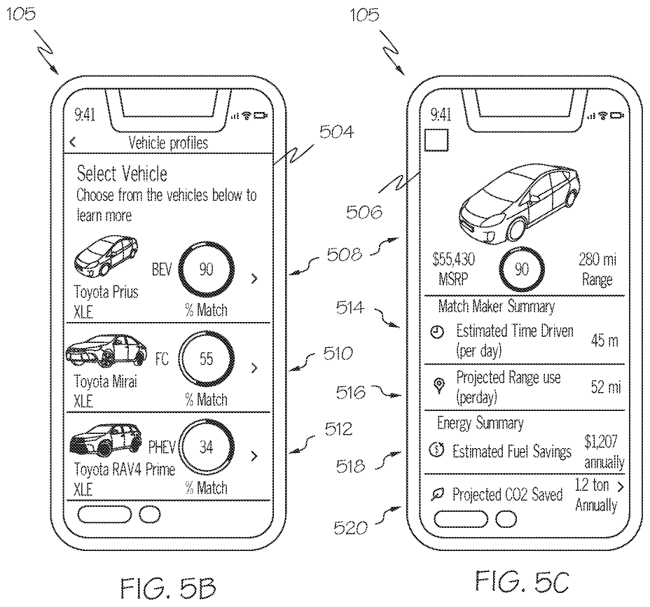

FIGS. 5A-5C depict various graphical interfaces displayed to a user throughout the processes described herein. FIG. 5A depicts an interface 400 which may be presented to a user on a display 102a of a computing device 102, for example. The interface 400 may be a web based application or webpage where a user can access their vehicle usage and/or driving behaviors and perform analytic operations. As described herein, an aspect of analyzing their behaviors, a user may query whether an alternative fuel vehicle may fit their current driving activities and if so how well does it fits. In some embodiments, the systems and methods described herein may be implemented as part of a vehicle manufacturer's or dealer's sales platform to assist a driver with identifying an alternative vehicle that fits their needs.

In some embodiments, one or more of the outputs generated at blocks 312, 316, 320, 324, and/or 330 may be compiled into a viewable and browseable report, for example, as depicted in FIG. 5A. For example, a recommendation 410 for a second vehicle 405, such as an alternative fuel vehicle, may be presented. For example, an image of the second vehicle 405 may be presented. The recommendation 410 may include vehicle information including but not limited to year, make, model, trim package, and the like. Additionally, a match score or match percentage 420 may be provided in response to the output generated at block 316, for example. One or more cost saving measures 430 may be provided in response to the output generated at block 320, for example. The cost savings measures 430 may be related to a fuel savings cost, cost of ownership, a difference between the cost of ownership of the recommended second vehicle compared to the driver's current vehicle, and/or the like. Additionally, an energy savings or a quantification of the environmental footprint 440 that the second vehicle would provide may be provided, for example, in response to the output generated at block 324. Furthermore, as discussed above, the method 300 may enable the user (driver) to schedule a test drive, obtain a quote, or obtain further information through on screen buttons 450.

In some embodiments, the systems and methods may be deployed on or connected to a user via a mobile device 105 as depicted in FIGS. 5B and 5C. FIGS. 5B and 5C illustrate example interfaces 504, 506 that may be presented and interacted with by the user on their mobile device 105 or in some embodiments computing device 102. A first interface 504, as shown in FIG. 5B, may provide a user with a list of alternative fuel vehicles 508, 510, 512 and a score indicating how well the vehicle matches to their present driving behaviors. The list of alternative fuel vehicles 508, 510, 512 may be different models having the same type of powertrain (e.g., BEVs, FCs, PHEVs, HEVs, or the like). Alternatively, the list of alternative fuel vehicles 508, 510, 512 may be different models having different types of powertrain (e.g., BEVs, FCs, PHEVs, HEVs, or the like). The user may select a vehicle from the list, for example, the first alternative fuel vehicle 508 to obtain additional information on the vehicle and the match score.

When the user selects a vehicle from the list, the first interface 504 may change to a second interface 506 as depicted in FIG. 5C. The second interface 506 may include additional specifications such as the estimated range of the vehicle 508 and estimated price of the vehicle 508. The second interface 506 may include a set of additional information pertaining to details regarding the match score such as a summary of the user's current estimated drive time 514 and the user's current projected driving range per day 516. These values may readily be compared by the user to the vehicle's overall range depicted in the additional information of the vehicle 508 at the top of the screen. Additionally, an energy summary field 518 may be generated and presented depicting aspects such as estimated fuel savings per year, cost of fueling the vehicle or a year, and the like. Furthermore, an environmental summary field 520 may be generated and presented. The environmental summary field 520 may include one or more of a variety of metrics that quantify and/or contextualize an environmental impact or savings that the driving the alternative fuel vehicle 508 (e.g., the second vehicle) would provide. These are only a few of many different interfaces that the systems and methods described herein may generate to provide information to a user and enable a user to interact with to obtain more information to inform their decision on an alternative fuel vehicle. In some embodiments, the systems and methods may be deployed through a sales kiosk or tablet provided at a dealership such that a user may access or provide driving data from their vehicle and receive an recommendation for an alternative fuel vehicle that best matches their needs and/or behaviors.

The functional blocks and/or flowchart elements described herein may be translated onto machine-readable instructions. As non-limiting examples, the machine-readable instructions may be written using any programming protocol, such as: (i) descriptive text to be parsed (e.g., such as hypertext markup language, extensible markup language, etc.), (ii) assembly language, (iii) object code generated from source code by a compiler, (iv) source code written using syntax from any suitable programming language for execution by an interpreter, (v) source code for compilation and execution by a just-in-time compiler, etc. Alternatively, the machine-readable instructions may be written in a hardware description language (HDL), such as logic implemented via either a field programmable gate array (FPGA) configuration or an application-specific integrated circuit (ASIC), or their equivalents. Accordingly, the functionality described herein may be implemented in any conventional computer programming language, as pre-programmed hardware elements, or as a combination of hardware and software components.

Embodiments described herein provide systems and methods for determining a recommendation for a vehicle, such as an alternative fuel vehicle. The recommendation may be generated by a rule-point based model, artificial intelligence models, trained machine learning models, or the like that are configured to ingest a vehicle driving dataset, such as vehicle usage behavior from a consumer's current vehicle and optionally information from the consumer in response to survey questions, and output at least one recommendation of a vehicle, such as an alternative fuel vehicle. In some embodiments, a method for determining alternative fuel vehicle options for a driver includes obtaining, with a controller, a vehicle driving dataset for a first vehicle, where the vehicle driving dataset comprises CAN bus data of the first vehicle logged for a period of time, transforming the vehicle driving dataset for the first vehicle into a set of alternative fuel parameters, determining, from a set of alternative fuel vehicles, a second vehicle having a specification that meets or exceeds a greatest number of parameters in the set of alternative fuel parameters; and outputting an alternative fuel vehicle recommendation comprising the second vehicle.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method for determining alternative fuel vehicle options for a driver, the method comprising:
obtaining, with a controller, a vehicle driving dataset for a first vehicle, wherein the vehicle driving dataset comprises CAN bus data of the first vehicle logged for a period of time;
assigning points to one or more alternative fuel vehicles based on application of a set of point-based rules to one or more subsets of the vehicle driving dataset;
identifying a second vehicle from the one or more alternative fuel vehicles having a greatest number of assigned points; and
outputting an alternative fuel vehicle recommendation comprising the second vehicle.

2. The method of claim 1, further comprising:
calculating a cost savings value for operating the second vehicle as difference between a cost of operation of the first vehicle and a cost of operation of the second vehicle; and
outputting the cost savings value for operating the second vehicle as an element of the alternative fuel vehicle recommendation.

3. The method of claim 1, further comprising:
calculating an environmental impact value for operating the second vehicle based on a difference between an emission for operating the first vehicle and an emission for operating the second vehicle; and
outputting the environmental impact value for operating the second vehicle.

4. The method of claim 1, wherein the first vehicle is an internal combustion engine vehicle and the second vehicle is at least one of a plug-in hybrid vehicle, a battery electric vehicle, a hybrid vehicle, a fuel cell vehicle, or a hybrid electric vehicle.

5. The method of claim 1, wherein the first vehicle is at least one of a plug-in hybrid vehicle, a battery electric vehicle, a hybrid vehicle, a fuel cell vehicle, a hybrid electric vehicle and the second vehicle is at least one of the plug-in hybrid vehicle, the battery electric vehicle, the hybrid vehicle, the fuel cell vehicle, or the hybrid electric vehicle.

6. The method of claim 1, wherein the period of time is greater than or equal to 24 hours, optionally greater than or equal to 7 days, optionally greater than or equal to 30 days, optionally greater than or equal to 60 days, optionally greater than or equal to 90 days.

7. The method of claim 1, wherein outputting the alternative fuel vehicle recommendation comprises causing a display device to display at least one of an image or a vehicle model of the second vehicle.

8. The method of claim 1, wherein outputting the alternative fuel vehicle recommendation comprises causing a communication device to generate and send an electronic message to at least one of the driver of the first vehicle or a vehicle dealer.

9. A method for determining alternative fuel vehicle options for a driver, the method comprising:
obtaining, with a controller, a vehicle driving dataset for a first vehicle, wherein the vehicle driving dataset comprises CAN bus data of the first vehicle logged for a predetermined period of time;
transforming the vehicle driving dataset for the first vehicle into a set of alternative fuel parameters;
determining, from a set of alternative fuel vehicles, a second vehicle having a specification that meets or exceeds a greatest number of parameters in the set of alternative fuel parameters; and
outputting an alternative fuel vehicle recommendation comprising the second vehicle.

10. The method of claim 9, wherein the vehicle driving dataset further comprises location tracking data defining a travel route of the first vehicle during the predetermined period of time.

11. The method of claim 9, further comprising:
determining a match percentage based on a comparison of the specification of the second vehicle and the set of alternative fuel parameters; and
outputting the match percentage as an element of the alternative fuel vehicle recommendation.

12. The method of claim 9, further comprising:
calculating a cost savings value for operating the second vehicle as difference between a cost of operation of the first vehicle and a cost of operation of the second vehicle; and
outputting the cost savings value for operating the second vehicle as an element of the alternative fuel vehicle recommendation.

13. The method of claim 9, further comprising:
calculating an environmental impact value for operating the second vehicle based on a difference between an emission for operating the first vehicle and an emission for operating the second vehicle; and
outputting the environmental impact value for operating the second vehicle.

14. The method of claim 9, wherein outputting the alternative fuel vehicle recommendation comprises causing a display device to display at least one of an image or a vehicle model of the second vehicle.

15. The method of claim 9, wherein outputting the alternative fuel vehicle recommendation comprises causing a communication device to generate and send an electronic message to at least one of the driver of the first vehicle or a vehicle dealer.

16. The method of claim 9, wherein the first vehicle is an internal combustion engine vehicle and the second vehicle is at least one of a plug-in hybrid vehicle, a battery electric vehicle, a hybrid vehicle, a fuel cell vehicle, or a hybrid electric vehicle.

17. The method of claim 9, wherein the first vehicle is at least one of a plug-in hybrid vehicle, a battery electric vehicle, a hybrid vehicle, a fuel cell vehicle, a hybrid electric vehicle and the second vehicle is at least one of the plug-in hybrid vehicle, the battery electric vehicle, the hybrid vehicle, the fuel cell vehicle, or the hybrid electric vehicle.

18. A system for determining alternative fuel vehicle options for a driver, the system comprising:
a display device; and
a controller communicatively coupled to the display device, the controller comprising a processor and a non-transitory computer readable memory, wherein the controller is configured to:
obtain a vehicle driving dataset for a first vehicle, wherein the vehicle driving dataset comprises CAN bus data of the first vehicle logged for a period of time,
assign points to one or more alternative fuel vehicles based on application of a set of point-based rules to one or more subsets of the vehicle driving dataset,
identify a second vehicle from the one or more alternative fuel vehicles having a greatest number of assigned points, and
output to the display device an alternative fuel vehicle recommendation comprising the second vehicle.

19. The system of claim 18, wherein the controller is further configured to:
calculate a cost savings value for operating the second vehicle as difference between a cost of operation of the first vehicle and a cost of operation of the second vehicle;
calculate an environmental impact value for operating the second vehicle based on a difference between an emission for operating the first vehicle and an emission for operating the second vehicle; and
output to the display device the cost savings value for operating the second vehicle and the environmental impact value for operating the second vehicle as an element of the alternative fuel vehicle recommendation.

20. The system of claim 18, wherein the first vehicle is an internal combustion engine vehicle and the second vehicle is at least one of a plug-in hybrid vehicle, a battery electric vehicle, a hybrid vehicle, a fuel cell vehicle, or a hybrid electric vehicle.
